(19) United States
(12) Patent Application Publication
(10) Pub. No.: US 2012/0155344 A1
(43) Pub. Date: Jun. 21, 2012

(54) OUT-OF-BAND COMMUNICATION ON HARMONICS OF THE PRIMARY CARRIER IN A WIRELESS POWER SYSTEM

(75) Inventors: George A. Wiley, San Diego, CA (US); Zhen Ning Low, San Diego, CA (US)

(73) Assignee: QUALCOMM Incorporated, San Diego, CA (US)

(21) Appl. No.: 13/213,005

(22) Filed: Aug. 18, 2011

Related U.S. Application Data
(60) Provisional application No. 61/423,997, filed on Dec. 16, 2010.

(51) Int. Cl. H04W 4/00

(52) U.S. Cl. 370/310; 455/129; 307/104

(57) ABSTRACT

Exemplary embodiments are directed to communication with a wireless power transmitter. A device may include an antenna for wirelessly transmitting a power carrier. The device may further include transmit circuitry coupled to the antenna and configured to transmit a data carrier at a frequency corresponding to at least one harmonic of the power carrier.

### CLAIM OF PRIORITY UNDER 35 U.S.C.§119

This application claims priority under 35 U.S.C.§119(e) to:

U.S. Provisional Patent Application 61/423,997 entitled “OUT-OF-BAND COMMUNICATION ON HARMONICS OF THE PRIMARY CARRIER IN A WIRELESS POWER SYSTEM” filed on Dec. 16, 2010, the disclosure of which is hereby incorporated by reference in its entirety.

### BACKGROUND

1. Field

The present invention relates generally to wireless power. More specifically, the present invention relates to communication between a wireless power transmitter and a wireless power receiver.

2. Background

Approaches are being developed that use over the air power transmission between a transmitter and the device to be charged. These generally fall into two categories. One is based on the coupling of plane wave radiation (also called far-field radiation) between a transmit antenna and receive antenna on the device to be charged which collects the radiated power and rectifies it for charging the battery. Antennas are generally of resonant length in order to improve the coupling efficiency. This approach suffers from the fact that the power coupling falls off quickly with distance between the antennas. So charging over reasonable distances (e.g., >1-2 m) becomes difficult. Additionally, since the system radiates plane waves, unintentional radiation can interfere with other systems if not properly controlled through filtering.

Other approaches are based on inductive coupling between a transmit antenna embedded, for example, in a “charging” mat or surface and a receive antenna plus a rectifying circuit embedded in the host device to be charged. This approach has the disadvantage that the spacing between transmit and receive antennas must be very close (e.g. mms). Though this approach does have the capability to simultaneously charge multiple devices in the same area, this area is typically small, hence the user must locate the devices to a specific area.

In a wireless power system, it may be beneficial for communication between a wireless power transmitter and one or more wireless power receivers in order to optimize power transfer, and be able to more effectively detect when non-compatible receivers are placed on a charging pad. Communication can also be used to support situations where transmitter and receiver capabilities are exchanged to provide enhanced features in higher-level applications.

A need exists for methods, systems, and devices to enable for enhanced communication between a wireless power transmitter and at least one wireless power receiver.

### SUMMARY OF THE INVENTION

One aspect of the subject matter described in the disclosure provides a device including an antenna for wirelessly transmitting a power carrier. The device further includes transmit circuitry coupled to the antenna and configured to transmit a data carrier at a frequency corresponding to at least one harmonic of the power carrier.

Another aspect of the subject matter described in the disclosure provides a device including an antenna for wirelessly receiving a power carrier. The device further includes receive circuitry coupled to the antenna and configured to demodulate a data signal at a frequency associated with at least one harmonic of the power carrier.

Yet another aspect of the subject matter described in the disclosure provides a method. The method includes generating a wireless power carrier including a plurality of harmonics. The method further includes transmitting a data carrier at a frequency associated with at least one harmonic of the wireless power carrier.

Another aspect of the subject matter described in the disclosure provides a method. The method includes wirelessly receiving a power carrier with an antenna. The method further includes demodulating a data carrier at a frequency associated with at least one harmonic of the power carrier.

Another aspect of the subject matter described in the disclosure provides a device that includes means for wirelessly receiving a power carrier with an antenna. The device further includes means for demodulating a data carrier at a frequency associated with at least one harmonic of the power carrier.

Another aspect of the subject matter described in the disclosure provides a device that includes means for generating a wireless power carrier including a plurality of harmonics. The device further includes means for transmitting a data carrier at a frequency associated with at least one harmonic of the wireless power carrier.

### BRIEF DESCRIPTION OF THE DRAWINGS

FIG. 1 shows a simplified block diagram of a wireless power transfer system.

FIG. 2 shows a simplified schematic diagram of a wireless power transfer system.

FIG. 3 illustrates a schematic diagram of a loop antenna for use in exemplary embodiments of the present invention.

FIG. 4 is a simplified block diagram of a transmitter, in accordance with an exemplary embodiment of the present invention.

FIG. 5 is a simplified block diagram of a receiver, in accordance with an exemplary embodiment of the present invention.

FIG. 6 is a plot illustrating a harmonic spectrum generated by a power amplifier.

FIG. 7 is a simplified illustration of a transmitter including a filter, in accordance with an exemplary embodiment of the present invention.

FIGS. 8A-8C depicts a transmitter including a filter, according to an exemplary embodiment of the present invention.

FIG. 9 illustrates a wireless power transmitter including a filter, in accordance with an exemplary embodiment of the present invention.

FIG. 10 is a block diagram of a system including a transmitter and a receiver, according to an exemplary embodiment of the present invention.

FIG. 11 is a block diagram of another system including a transmitter and a receiver, in accordance with an exemplary embodiment of the present invention.

FIG. 12 is a flowchart illustrating a method, in accordance with an exemplary embodiment of the present invention.

FIG. 13 is a flowchart illustrating another method, in accordance with an exemplary embodiment of the present invention.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

The term “wireless power” is used herein to mean any form of energy associated with electric fields, magnetic fields, electromagnetic fields, or otherwise that is transmitted between a transmitter and a receiver without the use of physical electrical conductors. Hereafter, all three of these will be referred to generically as radiated fields, with the understanding that pure magnetic or pure electric fields do not radiate power. These may be coupled to a “receiving antenna” to achieve power transfer.

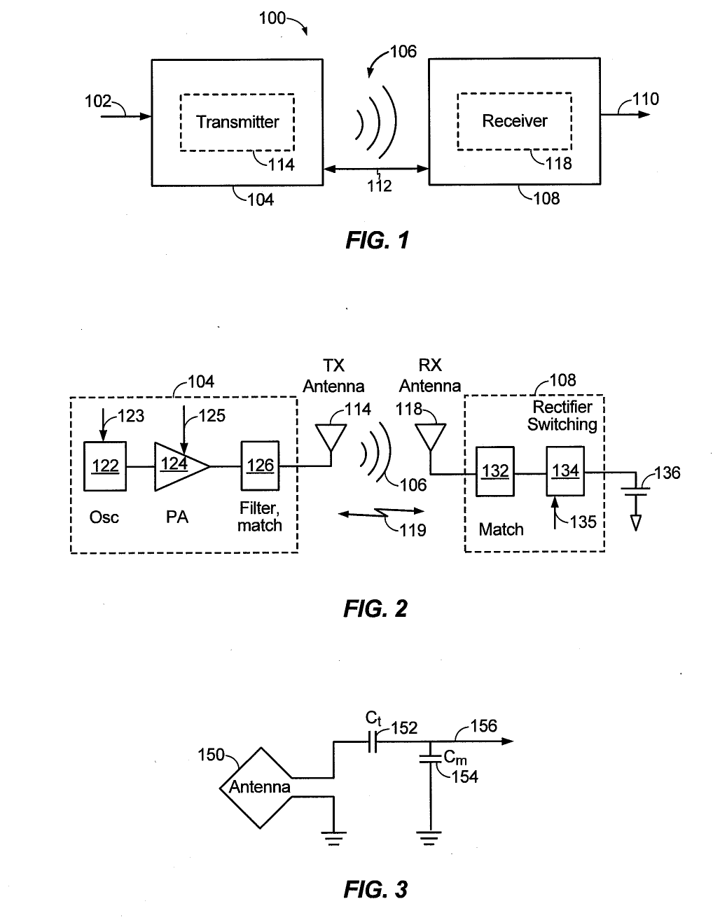

FIG. 1 illustrates a wireless transmission or charging system 100, in accordance with various exemplary embodiments of the present invention. Input power 102 is provided to a transmitter 104 for generating a field 106 for providing energy transfer. A receiver 108 couples to the field 106 and generates an output power 110 for storing or consumption by a device (not shown) coupled to the output power 110. Both the transmitter 104 and the receiver 108 are separated by a distance 112. In one exemplary embodiment, transmitter 104 and receiver 108 are configured according to a mutual resonant relationship and when the resonant frequency of receiver 108 and the resonant frequency of transmitter 104 are very close, transmission losses between the transmitter 104 and the receiver 108 are minimal when the receiver 108 is located in the “near-field” of the field 106.

Transmitter 104 further includes a transmit antenna 114 for providing a means for energy transmission and receiver 108 further includes a receive antenna 118 for providing a means for energy reception. The transmit and receive antennas are sized according to applications and devices to be associated therewith. As stated, an efficient energy transfer occurs by coupling a large portion of the energy in the near-field of the transmitting antenna to a receiving antenna rather than propagating most of the energy in an electromagnetic wave to the far field. When in this near-field a coupling mode may be developed between the transmit antenna 114 and the receive antenna 118. The area around the antennas 114 and 118 where this near-field coupling may occur is referred to herein as a coupling-mode region.

FIG. 2 shows a simplified schematic diagram of a wireless power transfer system. The transmitter 104 includes an oscillator 122, a power amplifier 124 and a filter and matching circuit 126. The oscillator is configured to generate at a desired frequency, such as 468.75 KHz, 6.78 MHz or 13.56 MHz, which may be adjusted in response to adjustment signal 123. The oscillator signal may be amplified by the power amplifier 124 with an amplification amount responsive to control signal 125. The filter and matching circuit 126 may be included to filter out harmonics or other unwanted frequencies and match the impedance of the transmitter 104 to the transmit antenna 114.

The receiver 108 may include a matching circuit 132 and a rectifier and switching circuit 134 to generate a DC power output to charge a battery 136 as shown in FIG. 2 or power a device coupled to the receiver (not shown). The matching circuit 132 may be included to match the impedance of the receiver 108 to the receive antenna 118. The receiver 108 and transmitter 104 may communicate on a separate communication channel 119 (e.g., Bluetooth, zigbee, cellular, etc).

As described more fully below, receiver 108, which may initially have a selectively disablable associated load (e.g., battery 136), may be configured to determine whether an amount of power transmitted by transmitter 104 and receiver by receiver 108 is sufficient for charging battery 136. Further, receiver 108 may be configured to enable a load (e.g., battery 136) upon determining that the amount of power is sufficient.

As illustrated in FIG. 3, antennas used in exemplary embodiments may be configured as a “loop” antenna 150, which may also be referred to herein as a “magnetic” antenna. Loop antennas may be configured to include an air core or a physical core such as a ferrite core. Air core loop antennas may be more tolerable to extraneous physical devices placed in the vicinity of the core. Furthermore, an air core loop antenna allows the placement of other components within the core area. In addition, an air core loop may more readily enable placement of the receive antenna 118 (FIG. 2) within a plane of the transmit antenna 114 (FIG. 2) where the coupled-mode region of the transmit antenna 114 (FIG. 2) may be more powerful.

As stated, efficient transfer of energy between the transmitter 104 and receiver 108 occurs during matched or nearly matched resonance between the transmitter 104 and the receiver 108. However, even when resonance between the transmitter 104 and receiver 108 are not matched, energy may be transferred, although the efficiency may be affected. Transfer of energy occurs by coupling energy from the near-field of the transmitting antenna to the receiving antenna residing in the neighborhood where this near-field is established rather than propagating the energy from the transmitting antenna into free space.

The resonant frequency of the loop or magnetic antennas is based on the inductance and capacitance. Inductance in a loop antenna is generally simply the inductance created by the loop, whereas, capacitance is generally added to the loop antenna's inductance to create a resonant structure at a desired resonant frequency. As a non-limiting example, capacitor 152 and capacitor 154 may be added to the antenna to create a resonant circuit that generates resonant signal 156. Accordingly, for larger diameter loop antennas, the size of capacitance needed to induce resonance decreases as the diameter or inductance of the loop increases. Furthermore, as the diameter of the loop or magnetic antenna increases, the efficient energy transfer area of the near-field increases. Of course, other resonant circuits are possible. As another non-limiting example, a capacitor may be placed in parallel between the two terminals of the loop antenna. In addition, those of ordinary skill in the art will recognize that for transmit antennas the resonant signal 156 may be an input to the loop antenna 150.

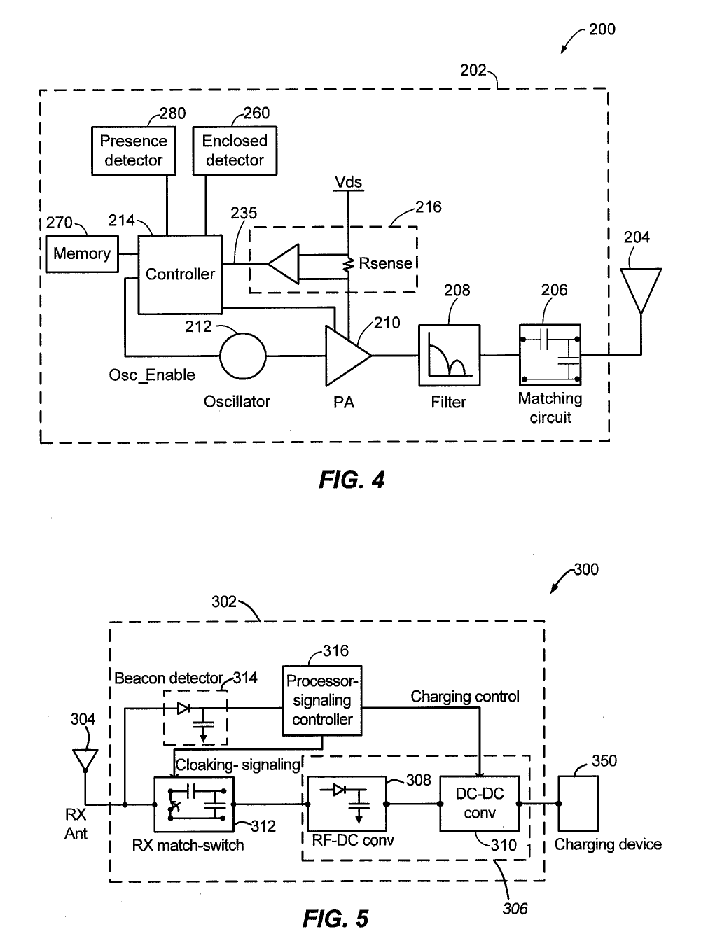

FIG. 4 is a simplified block diagram of a transmitter 200, in accordance with an exemplary embodiment of the present invention. The transmitter 200 includes transmit circuitry 202 and a transmit antenna 204. Generally, transmit circuitry 202 provides RF power to the transmit antenna 204 by providing an oscillating signal resulting in generation of near-field energy about the transmit antenna 204. It is noted that transmitter 200 may operate at any suitable frequency. By way of example, transmitter 200 may operate at the 13.56 MHz ISM band.

Exemplary transmit circuitry 202 includes a fixed impedance matching circuit 206 for matching the impedance of the transmit circuitry 202 (e.g., 50 ohms) to the transmit antenna 204 and a low pass filter (LPF) 208 configured to reduce harmonic emissions to levels to prevent self-jamming of devices coupled to receivers 108 (FIG. 1). Other exemplary embodiments may include different filter topologies, including but not limited to, notch filters that attenuate specific frequencies while passing others and may include an adaptive impedance match, that can be varied based on measurable transmit metrics, such as output power to the antenna or DC current drawn by the power amplifier. Transmit circuitry 202 further includes a power amplifier 210 configured to drive an RF signal as determined by an oscillator 212. The transmit circuitry may be comprised of discrete devices or circuits, or alternately, may be comprised of an integrated assembly. An exemplary RF power output from transmit antenna 204 may be on the order of 2.5 Watts.

Transmit circuitry 202 further includes a controller 214 for enabling the oscillator 212 during transmit phases (or duty cycles) for specific receivers, for adjusting the frequency or phase of the oscillator, and for adjusting the output power level for implementing a communication protocol for interacting with neighboring devices through their attached receivers. It is noted that the controller 214 may also be referred to herein as processor 214. As is well known in the art, adjustment of oscillator phase and related circuitry in the transmission path allows for reduction of out of band emissions, especially when transitioning from one frequency to another.

The transmit circuitry 202 may further include a load sensing circuit 216 for detecting the presence or absence of active receivers in the vicinity of the near-field generated by transmit antenna 204. By way of example, a load sensing circuit 216 monitors the current flowing to the power amplifier 210, which is affected by the presence or absence of active receivers in the vicinity of the near-field generated by transmit antenna 204. Detection of changes to the loading on the power amplifier 210 are monitored by controller 214 for use in determining whether to enable the oscillator 212 for transmitting energy and to communicate with an active receiver. As described more fully below, a current measured at power amplifier 210 may be used to determine whether an invalid device is positioned within a charging region of transmitter 200.

Transmit antenna 204 may be implemented with a Litz wire or as an antenna strip with the thickness, width and metal type selected to keep resistive losses low. In a conventional implementation, the transmit antenna 204 can generally be configured for association with a larger structure such as a table, mat, lamp or other less portable configuration. Accordingly, the transmit antenna 204 generally may not need “turns” in order to be of a practical dimension. An exemplary implementation of a transmit antenna 204 may be “electrically small” (i.e., fraction of the wavelength) and tuned to resonate at lower usable frequencies by using capacitors to define the resonant frequency.

The transmitter 200 may gather and track information about the whereabouts and status of receiver devices that may be associated with the transmitter 200. Thus, the transmitter circuitry 202 may include a presence detector 280, an enclosed detector 260, or a combination thereof, connected to the controller 214 (also referred to as a processor herein). The controller 214 may adjust an amount of power delivered by the amplifier 210 in response to presence signals from the presence detector 280 and the enclosed detector 260. The transmitter may receive power through a number of power sources, such as, for example, an AC-DC converter (not shown) to convert conventional AC power present in a building, a DC-DC converter (not shown) to convert a conventional DC power source to a voltage suitable for the transmitter 200, or directly from a conventional DC power source (not shown).

As a non-limiting example, the presence detector 280 may be a motion detector utilized to sense the initial presence of a device to be charged that is inserted into the coverage area of the transmitter. After detection, the transmitter may be turned on and the RF power received by the device may be used to toggle a switch on the Rx device in a pre-determined manner, which in turn results in changes to the driving point impedance of the transmitter.

As another non-limiting example, the presence detector 280 may be a detector capable of detecting a human, for example, by infrared detection, motion detection, or other suitable means. In some exemplary embodiments, there may be regulations limiting the amount of power that a transmit antenna may transmit at a specific frequency. In some cases, these regulations are meant to protect humans from electromagnetic radiation. However, there may be environments where transmit antennas are placed in areas not occupied by humans, or occupied infrequently by humans, such as, for example, garages, factory floors, shops, and the like. If these environments are free from humans, it may be permissible to increase the power output of the transmit antennas above the normal power restrictions regulations. In other words, the controller 214 may adjust the power output of the transmit antenna 204 to a regulatory level or lower in response to human presence and adjust the power output of the transmit antenna 204 to a level above the regulatory level when a human is outside a regulatory distance from the electromagnetic field of the transmit antenna 204.

As a non-limiting example, the enclosed detector 260 (may also be referred to herein as an enclosed compartment detector or an enclosed space detector) may be a device such as a sense switch for determining when an enclosure is in a closed or open state. When a transmitter is in an enclosure that is in an enclosed state, a power level of the transmitter may be increased.

In exemplary embodiments, a method by which the transmitter 200 does not remain on indefinitely may be used. In this case, the transmitter 200 may be programmed to shut off after a user-determined amount of time. This feature prevents the transmitter 200, notably the power amplifier 210, from running long after the wireless devices in its perimeter are fully charged. This event may be due to the failure of the circuit to detect the signal sent from either the repeater or the receive coil that a device is fully charged. To prevent the transmitter 200 from automatically shutting down if another device is placed in its perimeter, the transmitter 200 automatic shut off feature may be activated only after a set period of lack of motion detected in its perimeter. The user may be able to determine the inactivity time interval, and change it as desired. As a non-limiting example, the time interval may be longer than that needed to fully charge a specific type of wireless device under the assumption of the device being initially fully discharged.

FIG. 5 is a simplified block diagram of a receiver 300, in accordance with an exemplary embodiment of the present invention. The receiver 300 includes receive circuitry 302 and a receive antenna 304. Receiver 300 further couples to device 350 for providing received power thereto. It should be noted that receiver 300 is illustrated as being external to device 350 but may be integrated into device 350. Generally, energy is propagated wirelessly to receive antenna 304 and then coupled through receive circuitry 302 to device 350.

Receive antenna 304 is tuned to resonate at the same frequency, or within a specified range of frequencies, as transmit antenna 204 (FIG. 4). Receive antenna 304 may be similarly dimensioned with transmit antenna 204 or may be differently sized based upon the dimensions of the associated device 350. By way of example, device 350 may be a portable electronic device having diametric or length dimension smaller that the diameter of length of transmit antenna 204. In such an example, receive antenna 304 may be implemented as a multi-turn antenna in order to reduce the capacitance value of a tuning capacitor (not shown) and increase the receive antenna's impedance. By way of example, receive antenna 304 may be placed around the substantial circumference of device 350 in order to maximize the antenna diameter and reduce the number of loop turns (i.e., windings) of the receive antenna and the inter-winding capacitance.

Receive circuitry 302 provides an impedance match to the receive antenna 304. Receive circuitry 302 includes power conversion circuitry 306 for converting a received RF energy source into charging power for use by device 350. Power conversion circuitry 306 includes an RF-to-DC converter 308 and may also in include a DC-to-DC converter 310. RF-to-DC converter 308 rectifies the RF energy signal received at receive antenna 304 into a non-alternating power while DC-to-DC converter 310 converts the rectified RF energy signal into an energy potential (e.g., voltage) that is compatible with device 350. Various RF-to-DC converters are contemplated, including partial and full rectifiers, regulators, bridges, doublers, as well as linear and switching converters.

Receive circuitry 302 may further include switching circuitry 312 for connecting receive antenna 304 to the power conversion circuitry 306 or alternatively for disconnecting the power conversion circuitry 306. Disconnecting receive antenna 304 from power conversion circuitry 306 not only suspends charging of device 350, but also changes the “load” as “seen” by the transmitter 200 (FIG. 2).

As disclosed above, transmitter 200 includes load sensing circuit 216 which detects fluctuations in the bias current provided to transmitter power amplifier 210. Accordingly, transmitter 200 has a mechanism for determining when receivers are present in the transmitter's near-field.

When multiple receivers 300 are present in a transmitter's near-field, it may be desirable to time-multiplex the loading and unloading of one or more receivers to enable other receivers to more efficiently couple to the transmitter. A receiver may also be cloaked in order to eliminate coupling to other nearby receivers or to reduce loading on nearby transmitters. This “unloading” of a receiver is also known herein as a “cloaking.” Furthermore, this switching between unloading and loading controlled by receiver 300 and detected by transmitter 200 provides a communication mechanism from receiver 300 to transmitter 200 as is explained more fully below. Additionally, a protocol can be associated with the switching which enables the sending of a message from receiver 300 to transmitter 200. By way of example, a switching speed may be on the order of 100 μsec.

In an exemplary embodiment, communication between the transmitter and the receiver refers to a device sensing and charging control mechanism, rather than conventional two-way communication. In other words, the transmitter may use on/off keying of the transmitted signal to adjust whether energy is available in the near-field. The receivers interpret these changes in energy as a message from the transmitter. From the receiver side, the receiver may use tuning and de-tuning of the receive antenna to adjust how much power is being accepted from the near-field. The transmitter can detect this difference in power used from the near-field and interpret these changes as a message from the receiver. It is noted that other forms of modulation of the transmit power and the load behavior may be utilized.

Receive circuitry 302 may further include signaling detector and beacon circuitry 314 used to identify received energy fluctuations, which may correspond to informational signaling from the transmitter to the receiver. Furthermore, signaling and beacon circuitry 314 may also be used to detect the transmission of a reduced RF signal energy (i.e., a beacon signal) and to rectify the reduced RF signal energy into a nominal power for awakening either un-powered or power-depleted circuits within receive circuitry 302 in order to configure receive circuitry 302 for wireless charging.

Receive circuitry 302 further includes processor 316 for coordinating the processes of receiver 300 described herein including the control of switching circuitry 312 described herein. Cloaking of receiver 300 may also occur upon the occurrence of other events including detection of an external wired charging source (e.g., wall/USB power) providing charging power to device 350. Processor 316, in addition to controlling the cloaking of the receiver, may also monitor beacon circuitry 314 to determine a beacon state and extract messages sent from the transmitter. Processor 316 may also adjust DC-to-DC converter 310 for improved performance.

As noted above, it may be advantageous for a wireless power transmitter to communicate with one or more wireless power receivers in order to enhance wireless power transfer capabilities. Communication solutions may include amplitude modulation of a power carrier, which may come at an expense of having to meet FCC requirements. Another solution may include modulation of a data carrier on a frequency that is not a harmonic of the power carrier. However, this has proven to be costly for various reasons, as will be appreciated by a person having ordinary skill in the art.

As will be understood by a person having ordinary skill in the art, when transmitting power wirelessly on an ISM frequency, particularly at 6.78 MHz, there are numerous ISM frequencies that are harmonics of 6.78 MHz such as 13.56 MHz, 27.12 MHz, 40.68 MHz, etc. Exemplary embodiments of the present invention relate to out-of-band communication utilizing one or more harmonics of a primary carrier in a wireless power system. More specifically, various exemplary embodiments of the present invention may include modulating an amplitude of at least one harmonic of a signal to enable for communication between a wireless power transmitter and one or more wireless power receivers. For example, a filter may be utilized to allow varying amounts of one or more harmonics (e.g., the second harmonic, the third harmonic, the fourth harmonic, or any combination thereof) of a power carrier to pass from a power amplifier through a transmit antenna. Accordingly, harmonics, which are conventionally undesired, may be used for communication, as will be explained more fully below. It is noted that modulation, according to various exemplary embodiments, is efficient in a wireless power system because a power amplifier within a wireless power transmitter is non-linear and is capable of operating only at a single frequency.

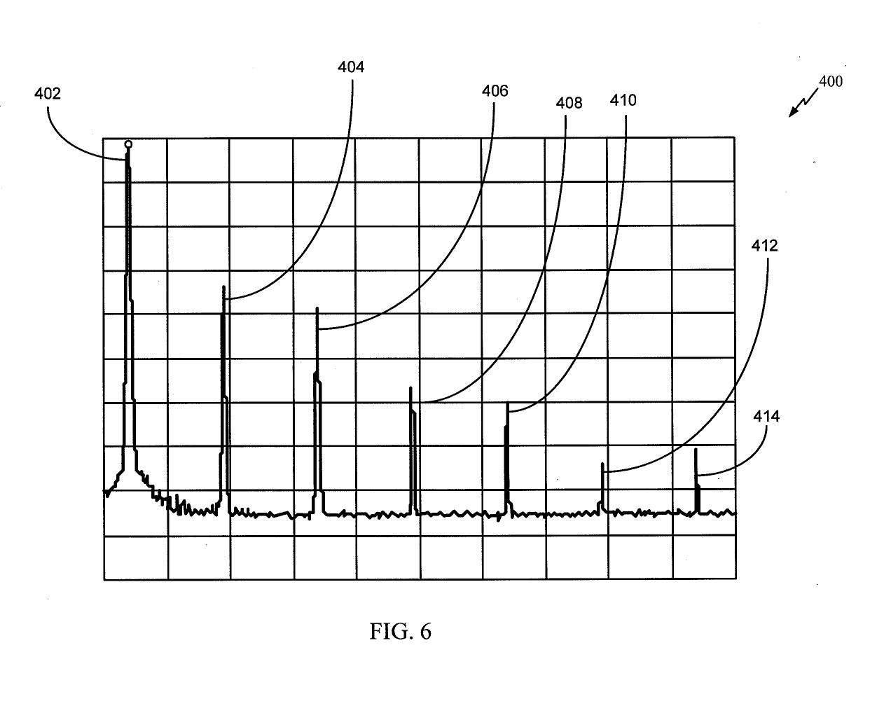

FIG. 6 is a plot depicting a harmonic spectrum 400 (i.e., a non-modulated carrier) generated by a power amplifier, such as power amplifier 210 illustrated in FIG. 4. As will be appreciated by a person having ordinary skill in the art, spectrum 400 includes a first harmonic (i.e., fundamental frequency), which is indicated by reference numeral 402. Further, spectrum 400 includes a second harmonic 404, a third harmonic 406, a fourth harmonic 408, a fifth harmonic 410, a sixth harmonic 412, and a seventh harmonic 414.

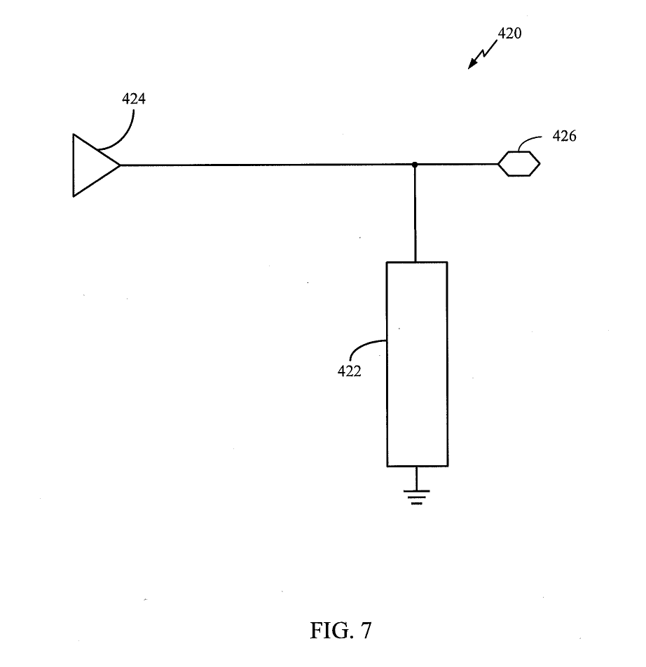

FIG. 7 depicts a portion of a transmitter 420 including a filter 422, in accordance with an exemplary embodiment of the present invention. Transmitter 420 may also comprise a power amplifier 424 (e.g., power amplifier 210 of FIG. 4) and an output 426. Filter 422 may comprise any suitable filter for filtering one or more harmonics of a signal. More specifically, filter 422 may be a controllable filter configured for modulating amplitude of one or more of the harmonics. In one example, the filter may be configured to either allow a harmonic of a signal to be transmitted via an output 426 or remove the harmonic prior to transmitting the signal via output 426.

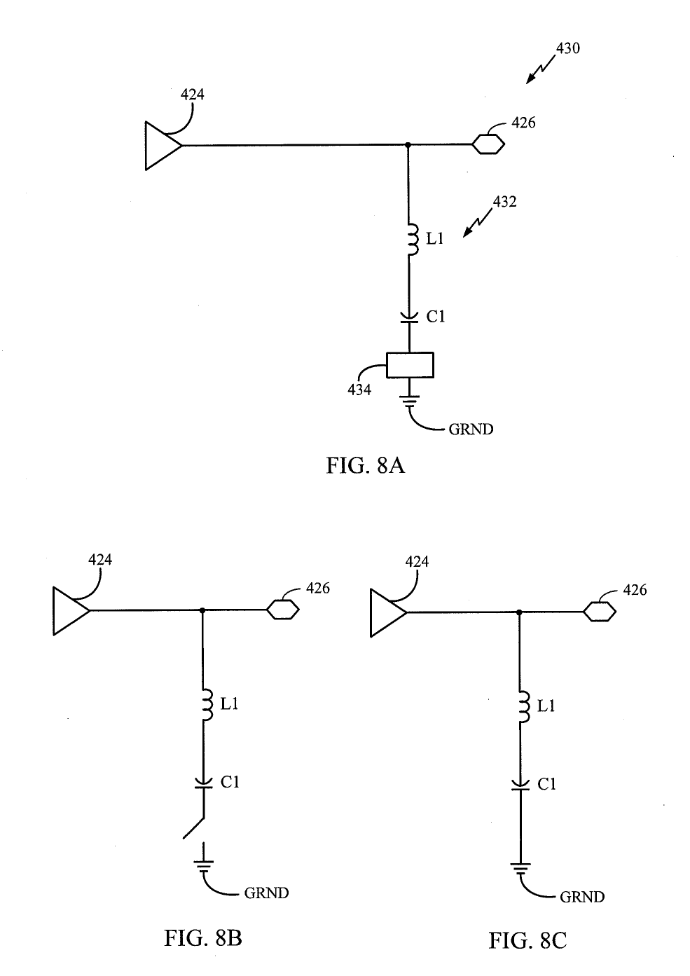

FIG. 8A depicts a portion of a transmitter 430 including a filter 432, in accordance with an exemplary embodiment of the present invention. Filter 432, which is one example of filter 422, includes an inductor L1 and a capacitor C1. Further, filter 432 includes a switching element 434, which is configured to either isolate capacitor C1 from a ground voltage GRND, as illustrated in FIG. 8B, or couple capacitor C1 to ground voltage GRND, as illustrated in FIG. 8C. A value of inductor L1 and a value of capacitor C1 may be selected to resonate at one or more selected harmonic frequencies of a wireless power carrier.

By way of example only, switching element 434 may comprise a field effect transistor (FET) having a gate configured to receive a control signal for enabling the FET to operate in a conductive state or a non-conductive state. More specifically, the FET may operate in a conductive state and, therefore, couple capacitor to ground voltage GRND upon receipt of a first control signal. Further, the FET may operate in a non-conductive state and, therefore, isolate capacitor from ground voltage GRND upon receipt of a second, different control signal.

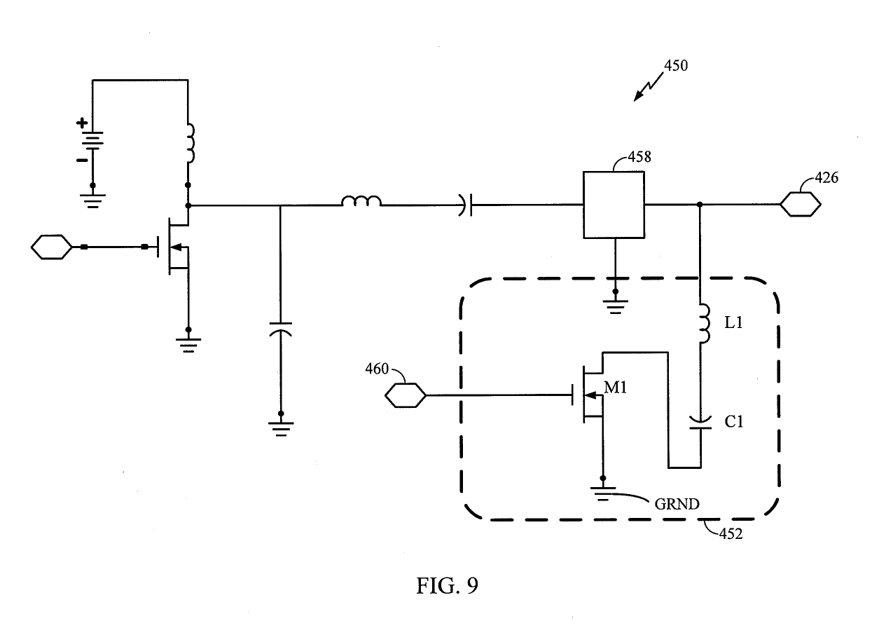

FIG. 9 is an illustration of a transmitter 450 including a filter 452, according to an exemplary embodiment of the present invention. Filter 452, which is one example of filter 432, includes inductor L1, a capacitor C1 and a field-effect transistor (FET) M1. FET M1 includes a drain coupled to capacitor C1, a source coupled to ground voltage GRND, and a gate configured to receive a control signal via input 460. Transmitter 450 may further include a low-pass filter 458. It is noted filter 452 may be positioned between low-pass filter 458 and output 426, as illustrated, or low-pass filter 458 may be positioned between filter 452 and output 426.

According to other exemplary embodiments of the present invention, other out-of-band modulation techniques (e.g., phase modulation and frequency modulation) may be utilized for communication between a wireless power transmitter and at least one wireless power receiver. More specifically, a data carrier may be generated and positioned at a location of a harmonic (e.g., a second harmonic, a third harmonic, or a fourth harmonic) of a power carrier. Stated another way, the data carrier may be at a frequency associated with the harmonic. Accordingly, the power carrier may be used as an accurate reference and, thus, demodulation of the signal may be simplified.

It is noted that since a wireless transmitter (e.g., transmitter 450) and one or more associated wireless receivers may be separated by a short distance, it may not be necessary to utilize a wireless power amplifier to transmit a data carrier. Stated another way, the amount of power needed to convey a data carrier at a short distance is substantially less than an amount of power required for wireless power transfer. Accordingly, an amplifier, which may be smaller than an amplifier used for power transmission, may be used to transmit a data carrier, as described more fully below. The data carrier may then be combined with a power carrier following a filtering network, or can be launched via a separate antenna co-located with the wireless power transmit antenna. While a separate amplifier may be more complex than the simple switching of a harmonic filter, as described above, a transmitter including multiple amplifiers may consume a very small area when integrated onto a wireless power IC.

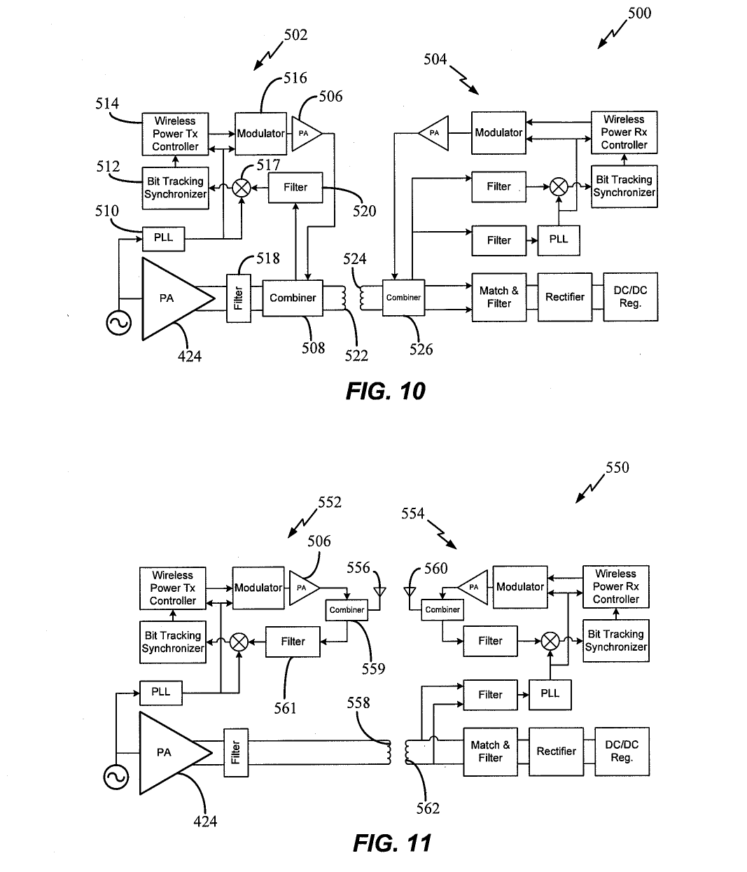

FIG. 10 illustrates a system 500 including a wireless power transmitter 502 and a wireless power receiver 504, according to an exemplary embodiment of the present invention. Transmitter 502 includes power amplifier 424 for generating a wireless power carrier and an amplifier 506 for generating a data carrier. Transmitter 502 also includes a phase-locked loop (PLL) 510, a synchronizer 512, a controller 514, a modulator 516, and a mixer 517. Further, transmitter 502 includes filters 518 and 520, a combiner 508, and an antenna 522. Combiner 508 may be configured for receiving and combining the data carrier output from amplifier 506 and the wireless power carrier output from power amplifier 424.

Phase-locked loop 510 may be configured to generate a multiple (i.e., a harmonic) of the power carrier, which may be used for both modulation of the forward link data signal, and for demodulation of the reverse link data signal. Bit tracking synchronizer 512 may be configured for generating a bit clock using the received demodulated data signal. The received data rate may be known, so the synchronizer may use a divided version of the carrier frequency to create the bit clock. Further, synchronizer 512 may be configured to detect transitions in the received data to realign the clock recovery logic to ensure the data clock is in sync with the received data. It is noted that synchronizer 512 may include either an integer divider or a fractional divider. Controller 514 is configured to provide all of the housekeeping functions for the transmitter, and is configured to generate the transmitted data packets, and receive data from the devices being charged. Mixer 517, in this exemplary embodiment, is used for demodulation of a BPSK modulated data signal received from the devices being charged. Modulator 516 may be configured to use the carrier frequency from the PLL 510 and the transmit data sequence from controller 514, and, in this example, may perform phase modulation to create the transmitted data signal. According to an exemplary embodiment, the data carrier may be combined with the wireless power carrier in a manner to enable the data carrier to be located at a harmonic of the wireless power carrier.

Receiver 504 includes an antenna 524 coupled to a combiner 526. Combiner 526 may be configured to separate the data carrier from the power carrier. Further, receiver 504 includes circuitry for processing each of the data carrier and wireless power carrier. It is noted that receiver 504 may include circuitry (e.g., PLL, synchronizer, filters, etc.), similar to transmitter 502, which is configured to perform similar functionality, as will be appreciated by a person having ordinary skill in the art. In accordance with one exemplary embodiment, the data carrier may be frequency modulated via, for example, modulation of PLL 510, a multiplexer (i.e., used to select between two or more frequencies), or a digital circuit, as will be appreciated by a person having ordinary skill in the art. More specifically, a binary data signal may be used to modulate an FM carrier, which enables for simplified modulation and demodulation. Further, phase-shift keying (PSK) or offset quadrature phase-shift keying (OQPSK) may be used.

With frequency modulation, one advantage of communicating on a harmonic is that a power carrier reference is always available, which allows receiver 504 to quickly capture the data signal. Moreover, as will be appreciated by a person having ordinary skill, in contrast to conventional receivers, with any type of PSK, receiver 504 may not require a carrier tracking loop for demodulating the data carrier. Rather, because the data carrier is located at a harmonic of the power carrier, the power carrier may be used as an accurate reference for demodulation of the data carrier. Additionally, if a bit rate is a sub-multiple of the carrier frequency, then a bit tracking timing loop may not be required. Only a simple edge-detection scheme may be required to locate the bit boundaries, as the bit-rate timing would be known by design. Further, even if the wireless power system is designed to use only a reverse link, it may be possible to add forward link communication at a harmonic of the power carrier to support enhanced services.

FIG. 11 illustrates a system 550 including a wireless power transmitter 552 and a wireless power receiver 554, according to an exemplary embodiment of the present invention. Transmitter 552 includes power amplifier 424 for generating a wireless power carrier and amplifier 506 for generating a data carrier. In contrast to transmitter 502, transmitter 552 includes a plurality of antennas, wherein an antenna 556 is configured for transmitting a data carrier and antenna 558 is configured for transmitting a wireless power carrier. According to an exemplary embodiment, the data carrier may be synced with the wireless power carrier in a manner to enable the data carrier be located at a harmonic of the wireless power carrier. Combiner 559 may comprise a passive circuit that connects the transmitted signal from the PA 506 to the antenna 556, and routes the received signal from antenna 556 to a receive filter 561. Depending on the implementation, combiner can perform various functions. In one exemplary embodiment, transmission and reception are half-duplex, and combiner 559 does nothing more than provide controlled-impedance connections between PA 506, filter, 561, and antenna 556, so the PA 506 does not short out a received signal, and filter 561 in the receive path does not adversely affect a transmit signal. According to another exemplary embodiment, combiner 559 may comprise a switch for coupling antenna 556 to either PA 506 or filter 561. This may require an additional control signal from the Tx or Rx controller to operate the switch. In yet another exemplary embodiment, combiner 559 may function like a diplexer filter in a mobile device, which would support having full-duplex communication, where the forward and reverse communication would take place on different harmonics of the power carrier. Receiver 554 includes an antenna 560 for receiving the data carrier and an antenna 562 for receiving the wireless power carrier.

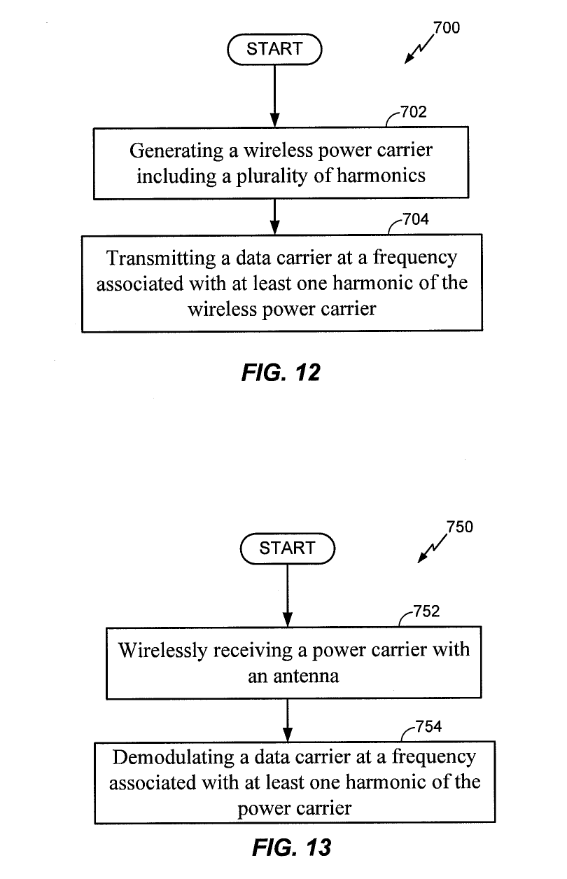

FIG. 12 is a flowchart illustrating a method 700, in accordance with one or more exemplary embodiments. Method 700 may include generating a wireless power carrier including a plurality of harmonics (depicted by numeral 702). Further, method 700 may include transmitting a data carrier at a frequency associated with at least one harmonic of the wireless power carrier (depicted by numeral 704).

FIG. 13 is a flowchart illustrating another method 750, in accordance with one or more exemplary embodiments. Method 750 may include wirelessly receiving a power carrier with an antenna (depicted by numeral 752). Further, method 750 may include demodulating a data carrier at a frequency associated with at least one harmonic of the power carrier (depicted by numeral 754).

As will be appreciated by a person having ordinary skill, out-of-band communication in a wireless power system may eliminate some or possibly all FCC requirements. Further, use of a harmonic of the power carrier for out-of-band communication may simplify the implementation and reduce component cost. Additionally, acquisition of the data carrier is relatively fast, and the system behavior is more repeatable. It is noted that although exemplary embodiments are described in relation to wireless power, exemplary embodiments of the present invention are not so limited. Rather, exemplary embodiments may be utilized in any suitable wireless application requiring communication between a transmitter and a receiver.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the exemplary embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the exemplary embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the exemplary embodiments shown herein but is to be accorded the widest scope consistent with the principles and novel features disclosed herein.

What is claimed is:

1. A device, comprising:
an antenna for wirelessly transmitting a power carrier; and
transmit circuitry coupled to the antenna and configured to transmit a data carrier at a frequency corresponding to at least one harmonic of the power carrier.

2. The device of claim 1, the transmit circuitry including a filter coupled to the antenna and configured to selectively modulate at least one harmonic of the power carrier.

3. The device of claim 2, the filter comprising:
an inductor;
a capacitor coupled to the inductor; and
a switching element coupled to the capacitor and for coupling the capacitor to a ground voltage.

4. The device of claim 1, the switching element comprising a field-effect transistor.

5. The device of claim 2, the filter comprising an LC filter configured to resonate at the at least one harmonic.

6. The device of claim 3, the transmit circuitry including a first amplifier for generating the power carrier and a second, different amplifier for generating the data carrier.

7. The device of claim 3, further comprising another antenna for transmitting the data carrier.

8. A device, comprising:
a first amplifier for generating a power carrier including a plurality of harmonics; and circuitry; and
a second amplifier for generating a data carrier at a frequency associated with at least one harmonic of the plurality.

9. The device of claim 8, further comprising a combiner for combining the power carrier and the data carrier.

10. The device of claim 8, the first amplifier coupled to a first antenna for transmitting the power carrier and the second amplifier coupled to a second antenna for transmitting the data carrier.

11. A device, comprising:
an antenna for wirelessly receiving a power carrier; and
receive circuitry coupled to the antenna and configured to demodulate a data signal at a frequency associated with at least one harmonic of the power carrier.

12. The device of claim 11, the receive circuitry configured to use a fundamental frequency of the power carrier as a reference to demodulate the data signal.

13. The device of claim 11, the receive circuitry configured to isolate the data signal from the power carrier.

14. The device of claim 11, further comprising another antenna for receiving the data signal.

15. A method, comprising:
generating a wireless power carrier including a plurality of harmonics; and
transmitting a data carrier at a frequency associated with at least one harmonic of the wireless power carrier.

16. The method of claim 15, further comprising selectively modulating at least one harmonic of the plurality of harmonics.

17. The method of claim 16, the modulating comprising selectively filtering at least one of a second harmonic, a third harmonic, and a fourth harmonic of the plurality of harmonics.

18. The method of claim 17, the filtering comprising resonating a filter including a capacitor and an inductor at a frequency of the at least one harmonic of the signal.

19. The method of claim 15, the transmitting comprising transmitting the power carrier with a first antenna and transmitting the data carrier with a second, different antenna.

20. The method of claim 15, further comprising combining the power carrier and the data carrier prior to transmitting the data carrier.

21. A method, comprising:
wirelessly receiving a power carrier with an antenna; and
demodulating a data carrier at a frequency associated with at least one harmonic of the power carrier.

22. The method of claim 21, the demodulating comprising using the power carrier as a reference to demodulate the data carrier.

23. The method of claim 21, further comprising isolating the data carrier from the power carrier.

24. The method of claim 21, further comprising wirelessly receiving the data carrier with another, different antenna.

25. A device, comprising:
means for wirelessly receiving a power carrier with an antenna; and
means for demodulating a data carrier at a frequency associated with at least one harmonic of the power carrier.

26. A device, comprising:
means for generating a wireless power carrier including a plurality of harmonics; and
means for transmitting a data carrier at a frequency associated with at least one harmonic of the wireless power carrier.
